(19) United States
(12) Patent Application Publication
(10) Pub. No.: US 2022/0135777 A1
(43) Pub. Date: May 5, 2022

(54) RUBBER COMPOSITION FOR TIRE AND PNEUMATIC TIRE USING SAME

(71) Applicant: The Yokohama Rubber Co., LTD., Tokyo (JP)

(72) Inventor: Kensuke HIJIKATA, Kanagawa (JP)

(21) Appl. No.: 17/310,272

(22) PCT Filed: Dec. 19, 2019
(86) PCT No.: PCT/JP2019/049896

§ 371 Date: Jul. 27, 2021

(30) Foreign Application Priority Data
Jan. 31, 2019 (JP) 2019-015867
Jan. 31, 2019 (JP) 2019-015881

(51) Int. Cl. C08L 9/06; B60C 1/00

(52) U.S. Cl. CPC C08L 9/06; C08L 2205/03; B60C 1/0016

(57) ABSTRACT

In the present invention, in order to provide a rubber composition for a tire that can improve dry grip performance, enhance strength at break, exhibit excellent wear resistance, and suppress temperature dependency of hardness, from 50 to 200 parts by mass of carbon black having a nitrogen adsorption specific surface area (N₂SA) from 100 to 500 m²/g and from 5 to 50 parts by mass of a terpene phenol resin having an acid value of 30 mgKOH/g or greater and a hydroxyl value of 5 mgKOH/g or greater are blended, per 100 parts by mass of a diene rubber containing a styrene-butadiene copolymer rubber.

### TECHNICAL FIELD

The present technology relates to a rubber composition for a tire and a pneumatic tire using the same, and particularly relates to a rubber composition for a tire that can improve dry grip performance, enhance strength at break, exhibit excellent wear resistance, and suppress the temperature dependency of hardness, and a pneumatic tire using the same.

Furthermore, the present technology relates to a rubber composition for a tire that improves wet grip performance, particularly warm-up performance (wet grip performance at low temperatures), enhances strength at break, and exhibits excellent wear resistance, and a pneumatic tire using the same.

### BACKGROUND ART

In general, various performances are required of pneumatic racing tires. Especially, pneumatic racing tires are required to have excellent steering stability (dry grip performance) on a dry road surface at the time of high-speed traveling, and, additionally, to suppress changes in its performances (wear skin and loss of grip caused by heat) at the time of high-speed traveling at a circuit for a long time.

Therefore, in order to improve, for example, dry grip performance, a filler having a high specific surface area or a high-softening-point resin is blended in a large amount.

However, when a filler having a high specific surface area is blended in a large amount, strength at break decreases, which leads to a deterioration in wear resistance. On the other hand, when a high-softening-point resin is blended in a large amount, the temperature dependency of hardness occurs and heat-caused loss of grip performance deteriorates, which causes a decrease in time in races.

As an attempt to enhance dry grip performance, for example, Japan Unexamined Patent Publication No. 2007-186567 describes a rubber composition in which silica having a high specific surface area, and a resin component having a high Tg and a resin component having a low Tg are blended in a diene rubber.

However, it is difficult for the technique to improve both the temperature dependency of hardness and wear resistance.

On the other hand, a tire for traveling on a dry road surface and a tire for traveling on a wet road surface are prepared as the pneumatic racing tires, and an optimal tire for each of these tires is selected according to the weather and road surface state at the time of traveling. Here, the racing tire for traveling on a wet road surface contains a large amount of a polymer having a high glass transition temperature (high-Tg polymer), a resin having a high softening point (high-softening-point resin), and/or a filler having a high specific surface area to enhance wet grip performance.

However, blending of a high-Tg polymer or a high-softening-point resin in a large amount involves problems of an excessive increase in compound Tg and a decrease in warm-up performance (wet grip performance at low temperatures).

On the other hand, blending of a filler having a high specific surface area in a large amount involves problems of a decrease in strength at break and thus causes a deterioration in wear resistance.

As an attempt to enhance wet grip performance, for example, Japan Unexamined Patent Publication No. 2007-186567 describes a rubber composition in which silica having a high specific surface area, and a resin component having a high Tg and a resin component having a low Tg are blended in a diene rubber.

However, it is difficult for the technique to improve both wet grip performance and wear resistance.

### SUMMARY

The present technology provides a rubber composition for a tire that can improve dry grip performance, enhance strength at break, exhibit excellent wear resistance, and suppress the temperature dependency of hardness, and a pneumatic tire using the same.

The present technology provides a rubber composition for a tire that improves wet grip performance, maintains or enhances warm-up performance (wet grip performance at low temperatures) and strength at break, and exhibits excellent wear resistance, and a pneumatic tire using the same.

As a result of diligent research, the inventors found that the first problem described above can be solved by blending a specific amount of carbon black having a specific nitrogen adsorption specific surface area (N₂SA) range and a specific amount of a terpene phenol resin having a specific acid value range and a specific hydroxyl value range in a diene rubber containing a styrene-butadiene copolymer rubber, and thus could complete the present technology.

Also, the inventors, as a result of diligent research, found that the second problem described above can be solved by blending a specific amount of silica having a specific CTAB (cetyltrimethylammonium bromide) specific surface area range and a specific amount of a terpene phenol resin having a specific acid value range and a specific hydroxyl value range in a diene rubber containing a styrene-butadiene copolymer rubber having a glass transition temperature (Tg) within a specific range, and thus could complete the present technology.

The configuration of the present technology that can solve the first problem is illustrated in from 1 to 3, 7 and 8 below. Note that the following configuration of the present technology that can solve the first problem may be referred to as a “first technology”.

In addition, the configuration of the present technology that can solve the second problem is illustrated in from 4 to 6, 7 and 8 below. Note that the following configuration of the present technology that can solve the second problem may be referred to as a “second technology”.

1. A rubber composition for a tire containing:

from 50 to 200 parts by mass of carbon black having a nitrogen adsorption specific surface area (N₂SA) from 100 to 500 m²/g; and

from 5 to 50 parts by mass of a terpene phenol resin having an acid value of 30 mgKOH/g or greater and a hydroxyl value of 5 mgKOH/g or greater,

per 100 parts by mass of a diene rubber containing a styrene-butadiene copolymer rubber.

2. The rubber composition for a tire according to 1, wherein the styrene-butadiene copolymer rubber has a styrene content of 30 mass % or greater.

3. The rubber composition for a tire according to 1, further containing a liquid aromatic vinyl-conjugated diene rubber having a glass transition temperature (Tg) of −40° C. or higher.

4. A rubber composition for a tire containing:

from 75 to 200 parts by mass of silica having a CTAB specific surface area from 100 to 400 m²/g; and

from 5 to 50 parts by mass of a terpene phenol resin having an acid value of 30 mgKOH/g or greater and a hydroxyl value of 5 mgKOH/g or greater,

per 100 parts by mass of a diene rubber containing a styrene-butadiene copolymer rubber having a glass transition temperature (Tg) of −20° C. or higher.

5. The rubber composition for a tire according to 4, wherein the styrene-butadiene copolymer rubber has a styrene amount of 30 mass % or greater.

6. The rubber composition for a tire according to 4, further containing from 2 to 20 mass % of a sulfur-containing silane coupling agent represented by Formula (100) relative to the silica:

(A)ₐ(B)_{b}(C)_{c}(D)_{d}(R1)ₑSi_{(4-2a-b-c-d-e)/2} (100)

wherein A represents a divalent organic group having a sulfide group, B represents a monovalent hydrocarbon group having from 5 to 10 carbon atoms, C represents a hydrolyzable group, D represents an organic group having a mercapto group, R1 represents a monovalent hydrocarbon group having from 1 to 4 carbon atoms, and a to e satisfy the relationships: 0≤a<1, 0<b<1, 0<c<3, 0≤d<1, 0≤e<2, and 0<2a+b+c+d+e<4, provided that a and d are not simultaneously 0.

7. The rubber composition for a tire according to 1 or 4, which is used in a tire cap tread.

8. A pneumatic tire including the rubber composition for a tire according to 1 or 4 in a cap tread.

The rubber composition for a tire according to the first technology contains:

from 50 to 200 parts by mass of carbon black having a nitrogen adsorption specific surface area (N₂SA) from 100 to 500 m²/g; and

from 5 to 50 parts by mass of a terpene phenol resin having an acid value of 30 mgKOH/g or greater and a hydroxyl value of 5 mgKOH/g or greater,

per 100 parts by mass of a diene rubber containing a styrene-butadiene copolymer rubber.

Thus, it is possible to provide a rubber composition for a tire that can improve dry grip performance, enhance strength at break, exhibit excellent wear resistance, and suppress temperature dependency of hardness, and a pneumatic tire using the same.

Also, the rubber composition for a tire according to the second technology contains:

from 75 to 200 parts by mass of silica having a CTAB specific surface area from 100 to 400 m²/g; and

from 5 to 50 parts by mass of a terpene phenol resin having an acid value of 30 mgKOH/g or greater and a hydroxyl value of 5 mgKOH/g or greater,

per 100 parts by mass of a diene rubber containing a styrene-butadiene copolymer rubber having a glass transition temperature (Tg) of −20° C. or higher.

Thus, it is possible to provide a rubber composition for a tire that improves wet grip performance, maintains or enhances warm-up performance (wet grip performance at low temperatures) and strength at break, and exhibits excellent wear resistance, and a pneumatic tire using the same.

### DETAILED DESCRIPTION

The present technology will be described in further detail below.

### Diene Rubber

The diene rubber used in the first technology contains a styrene-butadiene copolymer rubber (SBR) as an essential component. When the entire amount of the diene rubber used in the first technology is taken as 100 parts by mass, the blended amount of the SBR is preferably from 60 to 100 parts by mass, and further preferably from 80 to 100 parts by mass. In addition to the SBR, any diene rubber that can be blended in ordinary rubber compositions may be used in the first technology, and examples thereof include natural rubber (NR), isoprene rubber (IR), butadiene rubber (BR), acrylonitrile-butadiene copolymer rubber (NBR), and ethylene-propylene-diene terpolymer (EPDM). These may be used alone, or two or more may be used in combination. Furthermore, the molecular weight and the microstructure thereof is not particularly limited. The diene rubber may be terminal-modified with an amine, amide, silyl, alkoxysilyl, carboxyl, or hydroxyl group or may be epoxidized.

The SBR used in the first technology preferably has a styrene content of 30 mass % or greater. By satisfying such a styrene content, the glass transition temperature (Tg) of the SBR increases, and dry grip performance can be enhanced. The styrene content is further preferably from 35 to 50 mass %.

The diene rubber used in the second technology contains a styrene-butadiene copolymer rubber (SBR) having a glass transition temperature (Tg) of −20° C. or higher as an essential component. When the entire amount of the diene rubber used in the second technology is taken as 100 parts by mass, the blended amount of the SBR having a Tg of −20° C. or higher may be determined by appropriately taking into account various conditions such as air temperature and weather, for example, in a case of a racing application. The blended amount of the SBR can be 100 parts by mass, is preferably from 15 to 85 parts by mass, further preferably from 25 to 75 parts by mass, and particularly preferably from 30 to 70 parts by mass. In addition to the SBR having a Tg of −20° C. or higher, any diene rubber that can be blended in ordinary rubber compositions may be used in the second technology. Examples thereof include an SBR having a Tg of lower than −20° C., natural rubber (NR), isoprene rubber (IR), butadiene rubber (BR), acrylonitrile-butadiene copolymer rubber (NBR), and ethylene-propylene-diene terpolymer (EPDM). These may be used alone, or two or more may be used in combination. Furthermore, the molecular weight and the microstructure thereof is not particularly limited. The diene rubber may be terminal-modified with an amine, amide, silyl, alkoxysilyl, carboxyl, or hydroxyl group or may be epoxidized.

In the SBR having a Tg of −20° C. or higher, the Tg is further preferably from −18 to −8° C.

Furthermore, the Tg referred to in the second technology is a glass transition temperature of the SBR in a state of being free of an oil-extending component (oil). For the Tg, a thermograph is measured by differential scanning calorimetry (DSC) at a rate of temperature increase of 20° C./min and the temperature at the midpoint of the transition region is defined as the glass transition temperature.

The SBR having a Tg of −20° C. or higher, which is used in the second technology, preferably has a styrene content of 30 mass % or greater. By satisfying such a styrene content, the glass transition temperature (Tg) of the SBR increases, and dry grip performance can be enhanced. The styrene content is further preferably from 33 to 50 mass %.

### Carbon Black

The carbon black used in the first technology is required to have a nitrogen adsorption specific surface area (N₂SA) from 100 to 500 m²/g.

When the nitrogen adsorption specific surface area (N₂SA) of the carbon black is less than 100 m²/g, dry grip performance will decrease, and strength at break will decrease, leading to a deterioration in wear resistance.

When the nitrogen adsorption specific surface area (N₂SA) of the carbon black exceeds 500 m²/g, strength at break will decrease along with a deterioration in carbon dispersion, leading to a deterioration in wear resistance.

A further preferred nitrogen adsorption specific surface area (N₂SA) of the carbon black used in the first technology is from 130 to 400 m²/g.

The nitrogen adsorption specific surface area (N₂SA) of the carbon black is a value calculated in accordance with JIS (Japanese Industrial Standard) K6217-2.

### Silica

The silica used in the second technology is preferably required to have a CTAB specific surface area from 100 to 400 m²/g.

When the CTAB specific surface area of the silica is less than 100 m²/g, strength at break will decrease, leading to a deterioration in wear resistance.

Furthermore, when the CTAB specific surface area of the silica exceeds 400 m²/g, the viscosity will become too high, leading to difficulty in processing.

A further preferred CTAB specific surface area of the silica used in the second technology is from 140 to 350 m²/g.

The CTAB specific surface area of the silica is determined in accordance with JIS K6217-3.

### Terpene Phenol Resin

The terpene phenol resin used in the first technology and the second technology is required to have an acid value of 30 mgKOH/g or greater and a hydroxyl value of 5 mgKOH/g or greater. When the acid value is less than 30 mgKOH/g, neither the dry grip performance nor the temperature dependency of hardness can be improved in the first technology, and neither the wet grip performance nor the wear resistance can be improved in the second technology. Furthermore, when the hydroxyl value is less than 5 mgKOH/g, the phenol content will decrease, and the effects of the first technology and the second technology cannot be achieved.

A further preferred acid value is from 40 to 150 mgKOH/g.

Also, a further preferred hydroxyl value is from 45 to 120 mgKOH/g.

A terpene phenol resin is obtained by reacting a terpene compound and a phenol, and any terpene phenol resin can be used as long as it is known and satisfies the conditions of the acid value and hydroxyl value in the first technology and the second technology.

Furthermore, the terpene phenol resin used in the first technology and the second technology has a softening point of preferably from 85 to 180° C.

Note that the acid value and hydroxyl value can be measured in accordance with JIS K 0070: 1992. Furthermore, the softening point can be measured in accordance with JIS K 6220-1: 2001.

The terpene phenol resin used in the first technology and the second technology is commercially available. Examples of the terpene phenol resin include Tamanol 803L, available from Arakawa Chemical Industries, Ltd. (acid value=50 mgKOH/g, hydroxyl value=15 mgKOH/g) and Tamanol 901 (acid value=50 mgKOH/g, hydroxyl value=45 mgKOH/g).

### Liquid Aromatic Vinyl-Conjugated Diene Rubber

In the first technology, a liquid aromatic vinyl-conjugated diene rubber having a glass transition temperature (Tg) of −40° C. or higher is preferably blended. By blending such a liquid aromatic vinyl-conjugated diene rubber, the glass transition temperature (Tg) of the rubber composition increases and dry grip performance can be enhanced. Furthermore, the liquid aromatic vinyl-conjugated diene rubber tends to conform to the diene rubber and exhibits its effect.

From the perspective of improving dry grip performance, the liquid aromatic vinyl-conjugated diene rubber is preferably a liquid styrene-butadiene copolymer (liquid SBR). A liquid SBR having a weight average molecular weight from 1000 to 100000 and preferably from 2000 to 80000 can be used. The “weight average molecular weight” in the present technology refers to a weight average molecular weight determined by gel permeation chromatography (GPC) based on calibration with polystyrene. For the glass transition temperature (Tg), a thermograph is measured by differential scanning calorimetry (DSC) at a rate of temperature increase of 20° C./min and the temperature at the midpoint of the transition region is defined as the glass transition temperature.

Note that the liquid rubber used in the first technology is liquid at 23° C. Therefore, it is distinguished from the diene rubber that is solid at this temperature.

The blended amount of the liquid aromatic vinyl-conjugated diene rubber is preferably from 20 to 80 parts by mass and further preferably from 30 to 70 parts by mass per 100 parts by mass of the diene rubber.

### Sulfur-Containing Silane Coupling Agent

In the second technology, a sulfur-containing silane coupling agent represented by Formula (100) below is preferably blended. By blending such a sulfur-containing silane coupling agent, wet grip performance can be further enhanced.

(A)ₐ(B)_{b}(C)_{c}(D)_{d}(R1)ₑSiO_{(4-2a-b-c-d-e)/2} (100)

wherein A represents a divalent organic group having a sulfide group, B represents a monovalent hydrocarbon group having from 5 to 10 carbon atoms, C represents a hydrolyzable group, D represents an organic group having a mercapto group, R1 represents a monovalent hydrocarbon group having from 1 to 4 carbon atoms, and a to e satisfy the relationships: 0≤a<1, 0<b<1, 0<c<3, 0≤d<1, 0≤e<2, and 0<2a+b+c+d+e<4, provided that a and d are not simultaneously 0.

The sulfur-containing silane coupling agent (polysiloxane) represented by Formula (100) and the production method thereof are publicly known and are disclosed, for example, in WO 2014/002750.

In Formula (100) above, A represents a divalent organic group having a sulfide group. Among these, a group represented by Formula (120) below is preferable.

*—(CH₂)ₙ—Sₓ—(CH₂)ₙ—* (120)

In Formula (120) above, n represents an integer from 1 to 10, among which an integer from 2 to 4 is preferable.

In Formula (120) above, x represents an integer from 1 to 6, among which an integer from 2 to 4 is preferable.

In Formula (120) above, * indicates a bond position.

Specific examples of the group represented by Formula (120) above include *—CH₂—S₂—CH₂—*, *—C₂H₄—S₂—C₂H₄—*, *—C₃H₆—S₂—C₃H₆—*, *—C₄H₈—S₂—C₄H₈—*, *—CH₂—S₄—CH₂—*, *—C₂H₄—S₄—C₂H₄—*, *—C₃H₆—S₄—C₃H₆—*, *—C₄H₈—S₄—C₄H₈—*.

In Formula (100) above, B represents a monovalent hydrocarbon group having from 5 to 20 carbon atoms, and specific examples thereof include a hexyl group, an octyl group, and a decyl group. B is preferably a monovalent hydrocarbon group having from 5 to 10 carbon atoms.

In Formula (100) above, C represents a hydrolyzable group, and specific examples thereof include an alkoxy group, a phenoxy group, a carboxyl group, and an alkenyloxy group. Among these, a group represented by Formula (130) below is preferable.

*—OR² (130)

In Formula (130) above, R² represents an alkyl group having from 1 to 20 carbon atoms, an aryl group having from 6 to 10 carbon atoms, an aralkyl group (aryl alkyl group) having from 6 to 10 carbon atoms, or an alkenyl group having from 2 to 10 carbon atoms, among which an alkyl group having from 1 to 5 carbon atoms is preferable. Specific examples of the alkyl group having from 1 to 20 carbon atoms include a methyl group, an ethyl group, a propyl group, a butyl group, a hexyl group, an octyl group, a decyl group, and an octadecyl group. Specific examples of the aryl group having from 6 to 10 carbon atoms include a phenyl group, and a tolyl group. Specific examples of the aralkyl group having from 6 to 10 carbon atoms include a benzyl group, and a phenylethyl group. Specific examples of alkenyl groups having from 2 to 10 carbon atoms include a vinyl group, a propenyl group, and a pentenyl group.

In Formula (130) above, * indicates a bond position.

In Formula (100) above, D is an organic group having a mercapto group.

Among these, a group represented by Formula (140) below is preferable.

*—(CH₂)ₘ—SH (140)

In Formula (140) above, m represents an integer of 1 to 10, among which an integer from 1 to 5 is preferable.

In Formula (140) above, * indicates a bond position.

Specific examples of the group represented by Formula (140) above include *—CH₂SH, *—C₂H₄SH, *—C₃H₆SH, *—C₄H₈SH, *—C₅H₁₀SH, *—C₆H₁₂SH, *—C₇H₁₄SH, *—C₈H₁₆SH, *—C₉H₁₈SH, and *—C₁₀H₂₀SH.

In Formula (100) above, R1 represents a monovalent hydrocarbon group having from 1 to 4 carbon atoms.

In Formula (100) above, a to e satisfy the relationships: 0≤a<1, 0<b<1, 0<c<3, 0≤d<1, 0≤e<2, and 0<2a+b+c+d+e<4, provided that a and d are not simultaneously 0.

In Formula (100) above, a is preferably 0<a≤0.50 from the perspective of improving the effect of the second technology.

In Formula (100) above, b is preferably 0<b, and more preferably 0.10≤b≤0.89, from the perspective of improving the effect of the second technology.

In Formula (100) above, c is preferably 1.2≤c≤2.0 from the perspective of improving the effect of the second technology.

In Formula (100) above, d is preferably 0.1≤d≤0.8 from the perspective of improving the effect of the second technology.

The weight average molecular weight of the polysiloxane is preferably from 500 to 2300, and more preferably from 600 to 1500, from the perspective of improving the effect of the second technology. The molecular weight of the polysiloxane in the second technology is determined by gel permeation chromatography (GPC) using toluene as a solvent based on calibration with polysiloxane.

The mercapto equivalent weight of the polysiloxane determined by the acetic acid/potassium iodide/potassium iodate addition-sodium thiosulfate solution titration method is preferably from 550 to 700 g/mol, and more preferably from 600 to 650 g/mol, from the perspective of having excellent vulcanization reactivity.

The polysiloxane is preferably a polysiloxane having from 2 to 50 siloxane units (—Si—O—) from the perspective of improving the effect of the second technology.

Note that other metals other than a silicon atom (e.g. Sn, Ti, and Al) are not present in the backbone of the polysiloxane.

The method of producing the polysiloxane is publicly known and, for example, the polysiloxane can be produced in accordance with the method disclosed in the WO 2014/002750.

Note that the silane coupling agent used in the second technology can also use sulfur-containing silane coupling agents other than the above ones. Examples of such sulfur-containing silane coupling agents include bis-(3-triethoxysilylpropyl)tetrasulfide, bis(3-triethoxysilylpropyl)disulfide, 3-trimethoxysilylpropylbenzothiazol tetrasulfide, γ-mercaptopropyltriethoxysilane, and 3-octanoylthiopropyltriethoxysilane.

The blended amount of the sulfur-containing silane coupling agent represented by Formula (100) is preferably from 2 to 20 mass % and even further preferably from 7 to 15 mass %, relative to the amount of the silica. Blending ratio of rubber composition according to first technology

The rubber composition according to the first technology contains:

from 50 to 200 parts by mass of carbon black having a nitrogen adsorption specific surface area (N₂SA) from 100 to 500 m²/g; and

from 5 to 50 parts by mass of a terpene phenol resin having an acid value of 30 mgKOH/g or greater and a hydroxyl value of 5 mgKOH/g or greater,

per 100 parts by mass of a diene rubber.

When the blended amount of the carbon black is less than 50 parts by mass, heat build-up will decline, dry grip performance will deteriorate, and conversely, when the blended amount thereof exceeds 200 parts by mass, strength at break will decline and wear resistance will deteriorate.

When the blended amount of the terpene phenol resin is less than 5 parts by mass, the blended amount will be insufficient, and the effect of the first technology will not be achievable. Conversely, when the blended amount exceeds 50 parts by mass, the temperature dependency of the hardness will deteriorate, and strength at break decreases and wear resistance will deteriorate.

Furthermore, in the rubber composition of the first technology, the blended amount of the carbon black is preferably from 70 to 180 parts by mass per 100 parts by mass of the diene rubber.

The blended amount of the terpene phenol resin is preferably from 10 to 40 parts by mass per 100 parts by mass of the diene rubber.

### Other Components

The rubber composition in the first technology may contain, in addition to the components described above, vulcanizing or crosslinking agents; vulcanizing or crosslinking accelerators; various fillers, such as zinc oxide, silica, clay, talc, and calcium carbonate; anti-aging agents; plasticizers; and other various additives commonly blended in rubber compositions. The additives are kneaded by a common method to obtain a composition that can then be used for vulcanization or crosslinking. Blended amounts of these additives may be any standard blended amount in the related art, so long as the technology is not hindered. Note that in the first technology, silica may not be blended.

### Blending Ratio of Rubber Composition According to Second Technology

The rubber composition according to the second technology contains:

from 75 to 200 parts by mass of silica having a CTAB specific surface area from 100 to 400 m²/g; and

from 5 to 50 parts by mass of a terpene phenol resin having an acid value of 30 mgKOH/g or greater and a hydroxyl value of 5 mgKOH/g or greater,

per 100 parts by mass of a diene rubber.

When the blended amount of the silica is less than 75 parts by mass, wet grip performance will deteriorate. Conversely, when the blended amount exceeds 200 parts by mass, strength at break decreases and wear resistance will deteriorate.

When the blended amount of the terpene phenol resin is less than 5 parts by mass, the blended amount will be insufficient, and the effect of the second technology will not be achievable. Conversely, when the blended amount exceeds 50 parts by mass, warm-up performance (wet grip performance at low temperatures) will decrease, and strength at break will decrease and wear resistance will deteriorate.

Furthermore, in the rubber composition of the second technology, the blended amount of the silica is preferably from 100 to 180 parts by mass per 100 parts by mass of the diene rubber.

The blended amount of the terpene phenol resin is preferably from 10 to 40 parts by mass per 100 parts by mass of the diene rubber.

### Other Components

The rubber composition in the second technology may contain, in addition to the components described above, vulcanizing or crosslinking agents; vulcanizing or crosslinking accelerators; various fillers, such as zinc oxide, carbon black, clay, talc, and calcium carbonate; anti-aging agents; plasticizers; and other various additives commonly blended in rubber compositions. The additives are kneaded by a common method to obtain a composition that can then be used for vulcanization or crosslinking. Blended amounts of these additives may be any standard blended amount in the related art, so long as the technology is not hindered.

Furthermore, the rubber composition according to an embodiment of the present technology is suitable for producing a pneumatic tire according to a known method of producing pneumatic tires and is preferably used in a cap tread, particularly, in a pneumatic racing tire cap tread.

### EXAMPLES

The present technology will be described in further detail by way of examples and comparative examples, but the present technology is not limited by these examples.

### Standard Example 1, Examples 1 to 5, and Comparative Examples 1 to 5

### Preparation of Sample

For the composition (part by mass) shown in Table 1, the components other than the vulcanization accelerators and sulfur were kneaded for 5 minutes in a 1.7-L sealed Banbury mixer. The rubber was then discharged outside of the mixer and cooled at room temperature. Thereafter, the rubber was placed in an identical mixer again, and the vulcanization accelerators and sulfur were then added to the mixture and further kneaded to obtain a rubber composition. Next, the rubber composition thus obtained was pressure vulcanized in a predetermined mold at 160° C. for 20 minutes to obtain a vulcanized rubber test piece, and then the test methods shown below were used to measure the physical properties of the vulcanized rubber test piece.

Dry grip performance: In accordance with JIS K6394, a viscoelastic spectrometer (available from Toyo Seiki Seisakusho, Co., Ltd.) was used to measure a tan δ (100° C.) under the following conditions: initial distortion=10%; amplitude=±2%, and frequency=20 Hz. The measurements were then used to evaluate dry grip performance. The results are expressed as index values with Standard Example 1 being assigned the value of 100. Larger index values indicate better dry grip performance.

Hardness: Measured at 20° C. and 100° C. in accordance with JIS K6253. The results are expressed as index values with Standard Example 1 being assigned the value of 100. Larger index values indicate higher hardness. Smaller differences in hardness measured at 20° C. and 100° C. indicate better heat-caused loss of grip performance.

Strength at break: The elongation at break was evaluated at 100° C. in a tensile test in accordance with JIS K6251. The results are expressed as index values with Standard Example 1 being assigned the value of 100. Larger index values indicate better strength at break and better wear resistance.

TABLE 1

| | Standard | Comparative | Comparative | Comparative |
|---|---|---|---|---|
| | Example 1 | Example 1 | Example 2 | Example 3 |
| SBR 1 *1 | 137.5 | 137.5 | 137.5 | 137.5 |
| SBR 2 *2 | — | — | — | — |
| Carbon black 1 *3 | 100.0 | — | 250.0 | 100.0 |
| Carbon black 2 *4 | — | 100.0 | — | — |
| Carbon black 3 *5 | — | — | — | — |
| Resin 1 *6 | 20.0 | 20.0 | 20.0 | — |
| Resin 2 *7 | — | — | — | 20.0 |
| Resin 3 *8 | — | — | — | — |
| Resin 4 *9 | — | — | — | — |
| Resin 5 *10 | — | — | — | — |
| Liquid SBR *11 | — | — | — | — |
| Oil *12 | 20.0 | 20.0 | 20.0 | 20.0 |
| Stearic acid *13 | 2.0 | 2.0 | 2.0 | 2.0 |
| Zinc oxide *14 | 2.0 | 2.0 | 2.0 | 2.0 |
| Anti-aging agent *15 | 2.0 | 2.0 | 2.0 | 2.0 |
| Vulcanization accelerator 1 *16 | 1.5 | 1.5 | 1.5 | 1.5 |
| Vulcanization accelerator 2 *17 | 2.0 | 2.0 | 2.0 | 2.0 |
| Sulfur *18 | 1.5 | 1.5 | 1.5 | 1.5 |
| Measurement result | | | | |
| Dry grip performance | 100 | 82 | 169 | 104 |
| Hardness (20° C.) | 100 | 95 | 163 | 102 |
| Hardness (100° C.) | 100 | 94 | 170 | 103 |
| Strength at break | 100 | 94 | 56 | 99 |

| | Comparative | | | |
|---|---|---|---|---|
| | Example 4 | Example 1 | Example 2 | Example 3 |
| SBR 1 *1 | 137.5 | 137.5 | 137.5 | — |
| SBR 2 *2 | — | — | — | 137.5 |
| Carbon black 1 *3 | 100.0 | 100.0 | 100.0 | 100.0 |
| Carbon black 2 *4 | — | — | — | — |
| Carbon black 3 *5 | — | — | — | — |
| Resin 1 *6 | — | — | — | — |
| Resin 2 *7 | — | — | — | — |
| Resin 3 *8 | 20.0 | — | — | — |
| Resin 4 *9 | — | 20.0 | — | 20.0 |
| Resin 5 *10 | — | — | 20.0 | — |
| Liquid SBR *11 | — | — | — | — |
| Oil *12 | 20.0 | 20.0 | 20.0 | 20.0 |
| Stearic acid *13 | 2.0 | 2.0 | 2.0 | 2.0 |
| Zinc oxide *14 | 2.0 | 2.0 | 2.0 | 2.0 |
| Anti-aging agent *15 | 2.0 | 2.0 | 2.0 | 2.0 |
| Vulcanization accelerator 1 *16 | 1.5 | 1.5 | 1.5 | 1.5 |
| Vulcanization accelerator 2 *17 | 2.0 | 2.0 | 2.0 | 2.0 |
| Sulfur *18 | 1.5 | 1.5 | 1.5 | 1.5 |
| Measurement result | | | | |
| Dry grip performance | 115 | 114 | 113 | 120 |
| Hardness (20° C.) | 105 | 104 | 105 | 101 |
| Hardness (100° C.) | 102 | 109 | 107 | 102 |
| Strength at break | 96 | 101 | 100 | 108 |

| | | | Comparative |
|---|---|---|---|
| | Example 4 | Example 5 | Example 5 |
| SBR 1 *1 | — | — | 137.5 |
| SBR 2 *2 | 137.5 | 137.5 | — |
| Carbon black 1 *3 | 100.0 | — | 100.0 |
| Carbon black 2 *4 | — | — | — |
| Carbon black 3 *5 | — | 100.0 | — |
| Resin 1 *6 | — | — | — |
| Resin 2 *7 | — | — | — |
| Resin 3 *8 | — | — | — |
| Resin 4 *9 | 20.0 | 20.0 | 70.0 |
| Resin 5 *10 | — | — | — |
| Liquid SBR *11 | 20.0 | — | — |
| Oil *12 | — | 20.0 | 20.0 |
| Stearic acid *13 | 2.0 | 2.0 | 2.0 |
| Zinc oxide *14 | 2.0 | 2.0 | 2.0 |
| Anti-aging agent *15 | 2.0 | 2.0 | 2.0 |
| Vulcanization accelerator 1 *16 | 1.5 | 1.5 | 1.5 |
| Vulcanization accelerator 2 *17 | 2.0 | 2.0 | 2.0 |
| Sulfur *18 | 1.5 | 1.5 | 1.5 |
| Measurement result | | | |
| Dry grip performance | 124 | 136 | 154 |
| Hardness (20° C.) | 94 | 109 | 85 |
| Hardness (100° C.) | 100 | 110 | 78 |
| Strength at break | 107 | 102 | 85 |

*1: SBR 1 (Nipol NS460, available from ZS Elastomers Co., Ltd.; styrene content = 25 mass %; oil-extended product with 37.5 parts by mass of an oil component added to 100 parts by mass of an SBR)
*2: SBR 2 (Nipol NS522, available from ZS Elastomer Co., Ltd.; styrene content = 39 mass %; oil-extended product with 37.5 parts by mass of an oil component added to 100 parts by mass of an SBR)
*3: Carbon black 1 (SEAST 9, available from Tokai Carbon Co., Ltd.; nitrogen adsorption specific surface area (N₂SA) = 142 m²/g)
*4: Carbon black 2 (Show Black N339, available from Cabot Japan K.K.; nitrogen adsorption specific surface area (N₂SA) = 94 m²/g)
*5: Carbon black 3 (CD2019, available from Columbian Chemicals; nitrogen adsorption specific surface area (_{N}2SA) = 340 m²/g)
*6: Resin 1 (Neopolymer 140S, available from JX Energy Corporation; C9 resin)
*7: Resin 2 (YS POLYSTER T130, available from Yasuhara Chemical Co., Ltd.; phenol-modified terpene resin; acid value = 0 mgKOH/g; hydroxyl value = 60 mgKOH/g)
*8: Resin 3 (YS POLYSTER S145, available from Yasuhara Chemical Co., Ltd.; phenol-modified terpene resin; acid value = 0 mgKOH/g; hydroxyl value =100 mgKOH/g)
*9: Resin 4 (Tamanol 803L, available from Arakawa Chemical Industries, Ltd.; terpene phenol resin; acid value = 50 mgKOH/g; hydroxyl value = 15 mgKOH/g)
*10: Resin 5 (Tamanol 901, available from Arakawa Chemical Industries, Ltd.; terpene phenol resin; acid value = 50 mgKOH/g; hydroxyl value = 45 mgKOH/g)
*11: Liquid SBR (RICON 100, available from Cray Valley); weight average molecular weight = 6400; styrene content = 25 weight %; vinyl content = 70 mass %)
*12: Oil (Extract No. 4S, available from Showa Shell Sekiyu K.K.)
*13: Stearic acid (Beads Stearic Acid YR, available from NOF Corporation)
*14: Zinc oxide (Zinc Oxide III, available from Seido Chemical Industry Co., Ltd.)
*15: Anti-aging agent (Santoflex 6PP, available from Solutia Europe)
*16: Vulcanization accelerator 1 (NOCCELER CZ-G, available from Ouchi Shinko Chemical Industrial Co., Ltd.)
*17: Vulcanization accelerator 2: NOCCELER TOT-N, available from Ouchi Shinko Chemical Industrial Co., Ltd.)
*18: Sulfur (Golden Flower oil-treated sulfur powder, available from Tsurumi Chemical Industry, Co., Ltd.)

From the results shown in Table 1, it can be seen that the rubber compositions of Examples 1 to 5 were obtained by blending: a specific amount of carbon black having a specific nitrogen adsorption specific surface area (N₂SA) range and a specific amount of a terpene phenol resin having a specific acid value range and a specific hydroxyl value range in a diene rubber containing a styrene-butadiene copolymer rubber, and thus had improved dry grip performance, enhanced strength at break, excellent wear resistance, and suppressed temperature dependency of hardness, as compared with Standard Example 1.

In contrast, the nitrogen adsorption specific surface area (N₂SA) of the carbon black in Comparative Example 1 is less than the lower limit specified in the first technology. Thus, dry grip performance and strength at break deteriorated, as compared with that in Standard Example 1.

Since the blended amount of the carbon black in Comparative Example 2 exceeds the upper limit specified in the first technology, strength at break deteriorated as compared with that in Standard Example 1.

In Comparative Examples 3 and 4, the acid value of the terpene phenol resin is less than the lower limit specified in the first technology. Thus, strength at break deteriorated, as compared with that in Standard Example 1.

Since the blended amount of the terpene phenol resin in Comparative Example 5 exceeds the upper limit specified in the first technology, the temperature dependency of hardness and the strength at break deteriorated as compared with those of Standard Example 1.

### Standard Example 2, Examples 6 to 10, and Comparative Examples 6 to 10

### Preparation of Sample

For the composition (part by mass) shown in Table 2, the components other than the vulcanization accelerators and sulfur were kneaded for 5 minutes in a 1.7-L sealed Banbury mixer. The rubber was then discharged outside of the mixer and cooled at room temperature. Thereafter, the rubber was placed in an identical mixer again, and the vulcanization accelerators and sulfur were then added to the mixture and further kneaded to obtain a rubber composition. Next, the rubber composition thus obtained was pressure vulcanized in a predetermined mold at 160° C. for 20 minutes to obtain a vulcanized rubber test piece, and then the test methods shown below were used to measure the physical properties of the unvulcanized rubber composition and the vulcanized rubber test piece.

Wet grip performance: tan δ (0° C.) was measured at an elongation deformation strain of 10±2%, a vibration frequency of 20 Hz, and a temperature of 0° C., using a viscoelastic spectrometer (available from Toyo Seiki Seisaku-sho, Ltd.) in accordance with JIS K 6394:2007. The results are expressed as index values with Standard Example 2 being assigned the value of 100. Larger index values indicate better wet grip performance.

Warm-up performance (wet grip performance at low temperatures): In the unvulcanized rubber composition, the average Tg of the blended diene rubber, resin component, and oil (including an oil which extended the diene rubber) was calculated. Note that the average Tg is a value calculated based on the weighted average of the Tg of the components. The results are expressed as index values with Standard Example 2 being assigned the value of 100. When the index value is large, an increase in compound Tg indicates a deterioration in warm-up performance (wet grip performance at low temperatures).

Strength at break: The elongation at break was evaluated at 100° C. in a tensile test in accordance with JIS K6251. The results are expressed as index values with Standard Example 2 being assigned the value of 100. Larger index values indicate better strength at break and better wear resistance.

TABLE 2

| | Standard | Comparative | Comparative | Comparative |
|---|---|---|---|---|
| | Example 2 | Example 6 | Example 7 | Example 8 |
| SBR 1 *19 | 137.5 | 137.5 | 137.5 | 137.5 |
| SBR 2 *20 | — | — | — | — |
| Silica 1 *21 | 100.0 | — | 250.0 | 100.0 |
| Silica 2 *22 | — | 100.0 | — | — |
| Carbon black *23 | 10.0 | 10.0 | 10.0 | 10.0 |
| Resin 1 *24 | 20.0 | 20.0 | 20.0 | — |
| Resin 2 *25 | — | — | — | 20.0 |
| Resin 3 *26 | — | — | — | — |
| Resin 4 *27 | — | — | — | — |
| Resin 5 *28 | — | — | — | — |
| Sulfur-containing silane coupling | 8.0 | 8.0 | 20.0 | 8.0 |
| agent 1 *29 | | | | |
| Sulfur-containing silane coupling | — | — | — | — |
| agent 2 *30 | | | | |
| Oil *31 | 20.0 | 20.0 | 20.0 | 20.0 |
| Stearic acid *32 | 2.0 | 2.0 | 2.0 | 2.0 |
| Zinc oxide *33 | 2.0 | 2.0 | 2.0 | 2.0 |
| Anti-aging agent *34 | 2.0 | 2.0 | 2.0 | 2.0 |
| Vulcanization accelerator 1 *35 | 1.5 | 1.5 | 1.5 | 1.5 |
| Vulcanization accelerator 2 *36 | 2.0 | 2.0 | 2.0 | 2.0 |
| Sulfur *37 | 1.5 | 1.5 | 1.5 | 1.5 |
| Measurement result | | | | |
| Wet grip performance | 100 | 103 | 113 | 103 |
| Warm-up performance | 100 | 100 | 100 | 102 |
| Strength at break | 100 | 94 | 67 | 98 |

| | Comparative | Example | Example | Example |
|---|---|---|---|---|
| | Example 9 | 6 | 7 | 8 |
| SBR 1 *19 | 137.5 | 137.5 | 137.5 | 137.5 |
| SBR 2 *20 | — | — | — | — |
| Silica 1 *21 | 100.0 | 100.0 | 100.0 | 100.0 |
| Silica 2 *22 | — | — | — | — |
| Carbon black *23 | 10.0 | 10.0 | 10.0 | 10.0 |
| Resin 1 *24 | — | — | — | — |
| Resin 2 *25 | — | — | — | — |
| Resin 3 *26 | 20.0 | — | — | — |
| Resin 4 *27 | — | 20.0 | — | 20.0 |
| Resin 5 *28 | — | — | 20.0 | — |
| Sulfur-containing silane coupling | 8.0 | 8.0 | 8.0 | — |
| agent 1 *29 | | | | |
| Sulfur-containing silane coupling | — | — | — | 8.0 |
| agent 2 *30 | | | | |
| Oil *31 | 20.0 | 20.0 | 20.0 | 20.0 |
| Stearic acid *32 | 2.0 | 2.0 | 2.0 | 2.0 |
| Zinc oxide *33 | 2.0 | 2.0 | 2.0 | 2.0 |
| Anti-aging agent *34 | 2.0 | 2.0 | 2.0 | 2.0 |
| Vulcanization accelerator 1 *35 | 1.5 | 1.5 | 1.5 | 1.5 |
| Vulcanization accelerator 2 *36 | 2.0 | 2.0 | 2.0 | 2.0 |
| Sulfur *37 | 1.5 | 1.5 | 1.5 | 1.5 |
| Measurement result | | | | |
| Wet grip performance | 108 | 106 | 108 | 113 |
| Warm-up performance | 103 | 97 | 99 | 100 |
| Strength at break | 94 | 101 | 100 | 100 |

| | Comparative | Example | Example |
|---|---|---|---|
| | Example 10 | 9 | 10 |
| SBR 1 *19 | 137.5 | 10.0 | 50.0 |
| SBR 2 *20 | — | 127.5 | 87.5 |
| Silica 1 *21 | 100.0 | 100.0 | 100.0 |
| Silica 2 *22 | — | — | — |
| Carbon black *23 | 10.0 | 10.0 | 10.0 |
| Resin 1 *24 | — | — | — |
| Resin 2 *25 | — | — | — |
| Resin 3 *26 | — | — | — |
| Resin 4 *27 | 70.0 | 20.0 | 20.0 |
| Resin 5 *28 | — | — | — |
| Sulfur-containing silane coupling | 8.0 | — | — |
| agent 1 *29 | | | |
| Sulfur-containing silane coupling | — | 8.0 | 8.0 |
| agent 2 *30 | | | |
| Oil *31 | 20.0 | 20.0 | 20.0 |
| Stearic acid *32 | 2.0 | 2.0 | 2.0 |
| Zinc oxide *33 | 2.0 | 2.0 | 2.0 |
| Anti-aging agent *34 | 2.0 | 2.0 | 2.0 |
| Vulcanization accelerator 1 *35 | 1.5 | 1.5 | 1.5 |
| Vulcanization accelerator 2 *36 | 2.0 | 2.0 | 2.0 |
| Sulfur *37 | 1.5 | 1.5 | 1.5 |
| Measurement result | | | |
| Wet grip performance | 132 | 102 | 109 |
| Warm-up performance | 114 | 92 | 97 |
| Strength at break | 85 | 101 | 100 |

*19: SBR 1 (trade name TUFDENE E680, available from Asahi Kasei Corporation; styrene content = 36 mass %; oil-extended product with 37.5 parts by mass of an oil component added to 100 parts by mass of an SBR; Tg of SBR 1 excluding the oil component = −15° C.)
*20: SBR 2 (Nipol NS522, available from ZS Elastomer Co., Ltd.; styrene content = 39 mass %; oil-extended product with 37.5 parts by mass of an oil component added to 100 parts by mass of an SBR; Tg of SBR 2 excluding the oil component = −25° C.)
*21: Silica 1 (Ultrasil 7000 GR, available from Evonik Industries AG; CTAB specific surface area = 160 m²/g)
*22: Silica 2 (Zeosil 1085GR, available from Solvay; CTAB specific surface area = 85 m²/g)
*23: Carbon black (Sho Black N339, available from Cabot Japan K.K.)
*24: Resin 1 (Neopolymer 140S, available from JX Energy Corporation; C9 resin)
*25: Resin 2 (YS POLYSTER T160, available from Yasuhara Chemical Co., Ltd.; phenol-modified terpene resin; acid value = 0 mgKOH/g; hydroxyl value = 60 mgKOH/g)
*26: Resin 3 (YS POLYSTER S145, available from Yasuhara Chemical Co., Ltd.; phenol-modified terpene resin; acid value = 0 mgKOH/g; hydroxyl value = 100 mgKOH/g)
*27: Resin 4 (Tamanol 803L, available from Arakawa Chemical Industries, Ltd.; terpene phenol resin; acid value = 50 mgKOH/g; hydroxyl value = 15 mgKOH/g)
*28: Resin 5 (Tamanol 901, available from Arakawa Chemical Industries, Ltd.; terpene phenol resin; acid value = 50 mgKOH/g; hydroxyl value = 45 mgKOH/g)
*29: Sulfur-containing silane coupling agent 1 (Si69, available from Evonik Degussa; bis(3-triethoxysilylpropyl)tetrasulfide)
*30: Sulfur-containing silane coupling agent 2 (compound that satisfies Formula (100) above, synthesized according to Synthesis Example 1 disclosed in WO 2014/002750; compositional formula = (—C₃H₆—S₄—C₃H₆—)_{0.083}(—C₈H₁₇)_{0.667}(—OC₂H₅)_{1.50}(—C₃H₆SH)_{0.167}SiO_{0.75}; average molecular weight = 860)
*31: Oil (Extract No. 4S, available from Showa Shell Sekiyu K.K.)
*32: Stearic acid (Beads Stearic Acid YR, available from NOF Corporation)
*33: Zinc oxide (Zinc Oxide III, available from Seido Chemical Industry Co., Ltd.)
*34: Anti-aging agent (Santoflex 6PP, available from Solutia Europe)
*35: Vulcanization accelerator 1 (NOCCELER CZ-G, available from Ouchi Shinko Chemical Industrial Co., Ltd.)
*36: Vulcanization accelerator 2: NOCCELER TOT-N, available from Ouchi Shinko Chemical Industrial Co., Ltd.)
*37: Sulfur (Golden Flower oil-treated sulfur powder, available from Tsurumi Chemical Industry, Co., Ltd.)

As can be seen from the results in Table 2, the rubber compositions of Examples 6 to 10 were obtained by blending: a specific amount of silica having a specific CTAB specific surface area range and a specific amount of a terpene phenol resin having a specific acid value range and a hydroxyl value range in a diene rubber containing a styrene-butadiene copolymer rubber having a glass transition temperature (Tg) within a specific range, and thus had improved wet grip performance and warm-up performance (wet grip performance at low temperatures), enhanced strength at break, and excellent wear resistance, as compared with Standard Example 2.

In contrast, in Comparative Example 6, the CTAB specific surface area of the silica is less than the lower limit specified in the second technology. Thus, strength at break deteriorated, as compared with that in Standard Example 2.

In Comparative Example 7, the blended amount of the silica exceeded the upper limit specified in the second technology. Thus, strength at break deteriorated, as compared with that in Standard Example 2.

In Comparative Examples 8 and 9, the acid value of the terpene phenol resin is less than the lower limit specified in the second technology. Thus, warm-up performance (wet grip performance at low temperature) and strength at break deteriorated, as compared with those in Standard Example 2.

Since the blended amount of the terpene phenol resin in Comparative Example 10 exceeds the upper limit specified in the second technology, warm-up performance (wet grip performance at low temperature) and strength at break deteriorated, as compared with those in Standard Example 2.

1. A rubber composition for a tire comprising:
from 50 to 200 parts by mass of carbon black having a nitrogen adsorption specific surface area (N₂SA) from 100 to 500 m²/g; and
from 5 to 50 parts by mass of a terpene phenol resin having an acid value of 30 mgKOH/g or greater and a hydroxyl value of 5 mgKOH/g or greater,
per 100 parts by mass of a diene rubber comprising a styrene-butadiene copolymer rubber.

2. The rubber composition for a tire according to claim 1, wherein the styrene-butadiene copolymer rubber has a styrene content of 30 mass % or greater.

3. The rubber composition for a tire according to claim 1, further comprising a liquid aromatic vinyl-conjugated diene rubber having a glass transition temperature (Tg) of −40° C. or higher.

4. A rubber composition for a tire comprising:
from 75 to 200 parts by mass of silica having a CTAB specific surface area from 100 to 400 m²/g; and
from 5 to 50 parts by mass of a terpene phenol resin having an acid value of 30 mgKOH/g or greater and a hydroxyl value of 5 mgKOH/g or greater,
per 100 parts by mass of a diene rubber containing a styrene-butadiene copolymer rubber having a glass transition temperature (Tg) of −20° C. or higher.

5. The rubber composition for a tire according to claim 4, wherein the styrene-butadiene copolymer rubber has a styrene content of 30 mass % or greater.

6. The rubber composition for a tire according to claim 4, further comprising from 2 to 20 mass % of a sulfur-containing silane coupling agent represented by Formula (100) relative to the silica:
(A)ₐ(B)_{b}(C)_{c}(D)_{d}(R1)ₑSiO_{(4-2a-b-c-d-e)/2} (100)
wherein A represents a divalent organic group containing a sulfide group, B represents a monovalent hydrocarbon group having from 5 to 10 carbon atoms, C represents a hydrolyzable group, D represents an organic group containing a mercapto group, R1 represents a monovalent hydrocarbon group having from 1 to 4 carbon atoms, and a to e satisfy the relationships: 0≤a<1, 0<b<1, 0<c<3, 0≤d<1, 0≤e<2, and 0<2a+b+c+d+e<4, provided that a and d are not simultaneously 0.

7. The rubber composition for a tire according to claim 1, which is used in a tire cap tread.

8. A pneumatic tire comprising the rubber composition for a tire according to claim 1 in a cap tread.

9. The rubber composition for a tire according to claim 4, which is used in a tire cap tread.

10. A pneumatic tire comprising the rubber composition for a tire according to claim 4 in a cap tread.
